(19) United States
(12) Patent Application Publication
(10) Pub. No.: US 2005/0073407 A1
(43) Pub. Date: Apr. 7, 2005

(54) Route planning system and method

(75) Inventors: Timothy W. Giraldin, Ladera Ranch, CA (US); Patrick W. Giraldin, Ladera Ranch, CA (US); Regan E. Kelly, Laguna Niguel, CA (US); Martin F. Crowley, Lake Forest, CA (US); Eric Couch, Trabuco Canyon, CA (US); Y-Tin Gross, Ladera Ranch, CA (US)

Correspondence Address: DUCKOR SPRADLING METZGER, 401 WEST A STREET, SUITE 2400, SAN DIEGO, CA, 92101-7915, US

(73) Assignee: SafeTzone Technologies Corp.

(21) Appl. No.: 10/716,800

(22) Filed: Nov. 18, 2003

Related U.S. Application Data
(60) Provisional application No. 60/427,875, filed on Nov. 19, 2002.
(60) Provisional application No. 60/427,901, filed on Nov. 19, 2002.
(60) Provisional application No. 60/427,874, filed on Nov. 19, 2002.
(60) Provisional application No. 60/427,875, filed on Nov. 19, 2002.
(60) Provisional application No. 60/427,731, filed on Nov. 19, 2002.
(60) Provisional application No. 60/427,713, filed on Nov. 19, 2002.

(51) Int. Cl. G08B 1/08

(52) U.S. Cl. 340/539.2; 701/200

(57) ABSTRACT

A system and method of communication are disclosed for communication for a confined area of a facility. Personal identification information of a guest is received into at least one of a set of stations distributed throughout the confined area. At least one person icon or place icon is displayed on a map of the confined area. A select signal indicative of at least one of said person icons or place icons is received. Direction indicia to the selected icon is displayed.

### RELATED APPLICATION

The following applications are related to the present invention and are hereby incorporated by reference in their entirety: U.S. patent application Ser. No. 09/992,872, titled “IDENTIFICATION TAG FOR REAL-TIME LOCATION OF PEOPLE,” filed Nov. 13, 2001, and U.S. patent application Ser. No. 09/992,668, filed Nov. 13, 2001 and titled “System for Real-Time Location of People in a Fixed Environment.”

This application claims priority to the following provisional applications and are hereby incorporated by reference in their entirety: U.S. Provisional Patent Application Ser. No. 60/427,901, titled MESSAGE COMMUNICATION SYSTEM AND METHOD, filed Nov. 19, 2002, U.S. Provisional Patent Application Ser. No. 60/427,874, titled QUEUE MANAGEMENT SYSTEM AND METHOD, filed Nov. 19, 2002, U.S. Provisional Patent Application Ser. No. 60/427,875, titled ROUTE PLANNING SYSTEM AND METHOD, filed Nov. 19, 2002, U.S. U.S. Provisional Patent Application Ser. No. 60/427,731, titled CASHLESS SPENDING SYSTEM AND METHOD, filed Nov. 19, 2002, and U.S. Provisional Patent Application Ser. No. 60/427,713, titled DATA ANALYSIS SYSTEM AND METHOD, filed Nov. 19, 2002.

This application claims priority to the following non-provisional applications and are hereby incorporated by reference in their entirety: U.S. Non-provisional Patent Application, Ser. No. ______, titled MESSAGE COMMUNICATION SYSTEM AND METHOD, filed Nov. 18, 2003, U.S. Non-provisional Patent Application, Ser. No. ______, titled QUEUE MANAGEMENT SYSTEM AND METHOD, filed Nov. 18, 2003, U.S. Non-provisional Patent Application, Ser. No. ______, titled CASHLESS SPENDING SYSTEM AND METHOD, filed Nov. 18, 2003, and U.S. Non-provisional Patent Application, Ser. No. ______, titled DATA ANALYSIS SYSTEM AND METHOD, filed Nov. 18, 2003.

### BACKGROUND OF THE INVENTION

1. Field of the Invention

The present invention relates in general to a route planning system and method. It more particularly relates to a route planning system and method, which may be employed in a confined commercial area of a facility such as a theme park, amusement park, large retail store, casino, ship or others.

2. Background Art

The information contained in this section relates to the background of the art of the present invention without any, admission as to whether or not any disclosure in this section legally constitutes prior art.

In large confined areas of facilities such as theme parks and amusement parks, groups of people such as families or other groups frequently attend and wander throughout the facility during a given interval of time such as one day. It frequently occurs that members of a given group separate, either voluntarily or accidentally. It is, therefore, sometimes desirable to locate members of a given group.

As disclosed in the above-identified patent applications, a person locating system has been employed to locate all of the members of a group in real time. Such a system has proven to be highly desirable and useful for many applications.

The system as disclosed in the foregoing mentioned patent applications employs an electronic system where a map of the confined area of a facility such as a park, is displayed and illustrates the locations of each person in the group to enable each member of the group to know the location of each other member of the same group. It, however, sometimes becomes difficult under certain circumstances to locate in a convenient manner a missing person or other person in the group, even though a map is provided. In this regard, the map may not always be sufficiently detailed to identify the entire or presently preferred route to the other person. For example, there may be bodies of water or other obstacles that are not shown on the map. There also may be parades or other activities temporarily blocking the route to the person in question at the time when it is desired to locate the person. Furthermore, there can be impediments such as steps to handicap persons in finding other persons of a group.

### BRIEF DESCRIPTION OF THE DRAWINGS

In the following, the invention will be explained in further detail with reference to the drawings, in which:

FIG. 1 is a diagrammatic view of a person locating system, which forms a part of the disclosed embodiments of the invention;

FIGS. 4, 5, 6, and 8 are screen shot diagrams of location station displays of the system of FIG. 1; and

FIGS. 2, 3, and 7 are flow chart diagrams of methods according to disclosed embodiments of the invention.

### DESCRIPTION OF CERTAIN EMBODIMENTS OF THE INVENTION

A system and method of communication are disclosed for communication for a confined area of a facility. Personal identification information of a guest is received into at least one of a set of stations distributed throughout the confined area. At least one person icon or place icon is displayed on a map of the confined area. A select signal indicative of at least one of said person icons or place icons is received. Direction indicia to the selected icon is displayed.

In accordance with disclosed embodiments of the invention, there is provided a route planning system and method, which relate to using stations distributed throughout a confined area of a facility, displaying on the stations a map of at least a portion of the confined area including the location of one or more members of a group, and designating a path between members of the group or between group members and places.

According to other embodiments of the invention, the path can be a direct path, a more advantageous path or a handicapped person's access path.

According to yet another disclosed embodiment of the invention, the location of amenities may be illustrated, and a path displayed between a person or location to the location of the desired amenity. According to the disclosed embodiments, the direction may be indicated by a series of path indicia. Such path indicia may be displayed as a continuous line, or in a series of spaced-apart discreet elements such as arrows, footprints, bars, or others. For example, the indicia may indicate direction such as arrows or pointed bars so that it is apparent to the group member or other person requesting the routing directions that the illustrated path is extending from the person requesting the information to the other group member or location. It is to be understood that while one of the disclosed embodiments of the invention relates to the display of an icon of the person requesting the routing instructions, it will become apparent to those skilled in the art that only the location station or other station where the user is making the request need be illustrated or otherwise described for certain applications. It is also to be understood that in place of a map, directions may be provided either by illustrating the text of the instructions or verbally communicated to the person requesting the information.

Person Locating System

Many patrons who visit large confined commercial facilities of a facility such as zoos, waterparks, theme parks, amusement parks, large retail stores, casinos, ships and others have at some point, experienced the feeling of temporarily losing another member of their group or family. It may be easy under some circumstances for an individual to become lost in a crowd, where the person only a short distance such as twenty feet away from the rest of the group and yet the group may not be able to find him or her.

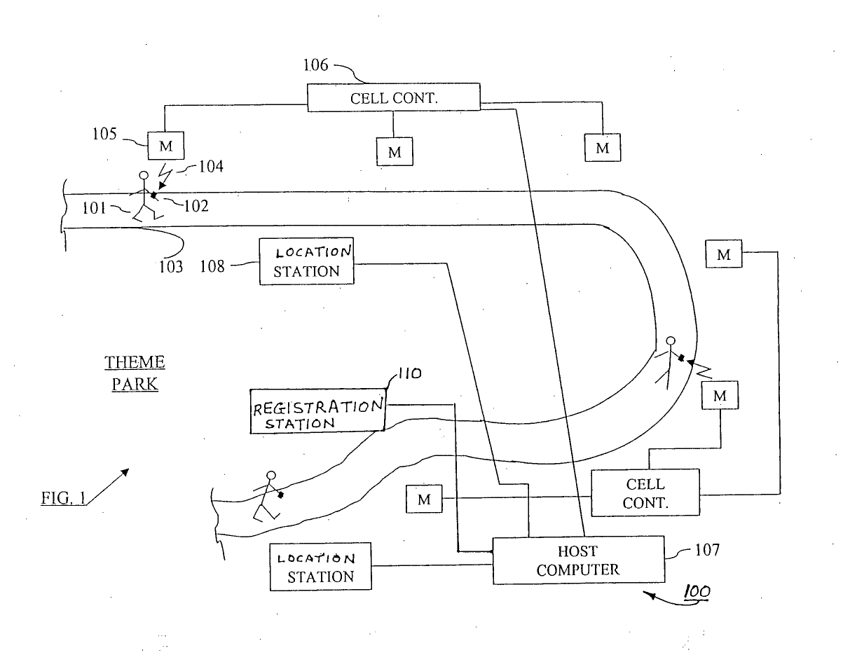

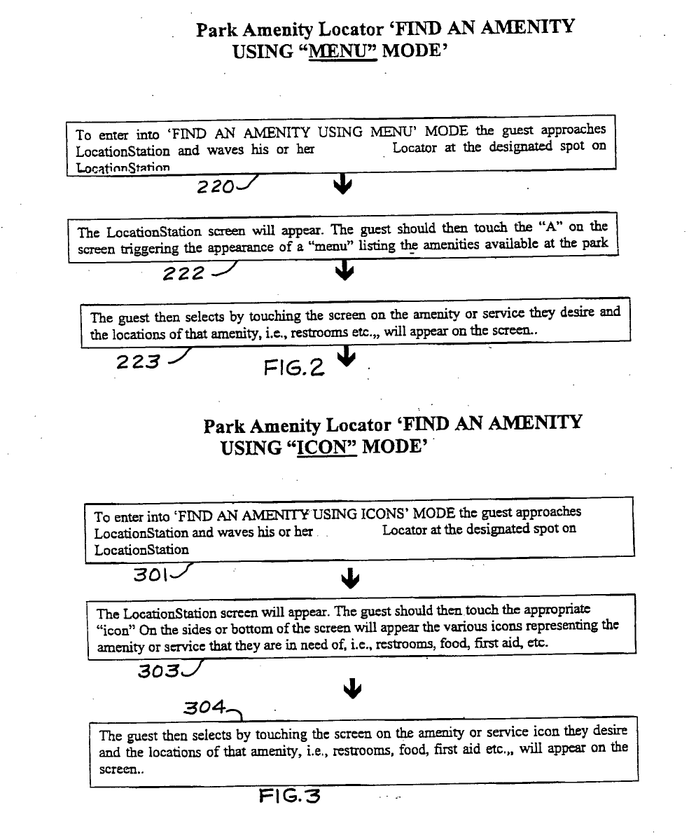

As shown in FIG. 1, an interactive person locating system 100 employs location stations such as station 108 distributed throughout the confined area to facilitate communication between and among member of the groups of patrons such as patron 101. A registration station 110 enables patrons to register their group so that members of the registered group can communicate privately with one another.

Group members or guests who interact with the system, at any location station, have the ability to visually discover the location of their group members on an electronic version of the facility or park map.

The members or guests are thus empowered to become a part of the solution in finding one another; to give them the ability to at least know where the rest of the party is when they cannot be found, or when they become separated by choice or by accident; to eliminate the feeling of panic that sweeps over a parent when they realize that a member of their group, such as their child, is not by their side or at the designated meeting place.

It helps for group members such as parents to know promptly that their children are still in the park, waiting in line for a ride or just running late.

Each member of a group obtains a waterproof transmitter in the form of a locator or personal identification (i.d.) tag 102 that is worn on the wrist or other part of the body or on the person's clothing. This locator continually communicates, via radio signal, with the child locating system 10 to update his or her location throughout the day. One example of such a tag is dislocated in the foregoing mentioned non-provisional patent application Ser. No. 09/992,872.

The location station 108 is a strategically placed interactive viewable workstation kiosk. These stations allow unaided guest access to the system with the locator 102. This gives the guest the ability to locate and view any locators in their group, to post messages on a private message board or to contact security. It also allows users to interact with any other system feature of module.

The registration station 110 is an interactive viewable workstation used by the park. The registration station 110 software module activates the locating software by enabling quick and easy registration of groups and individuals into the system 100 so that the system distinguishes between groups and between individuals within groups.

The confined area such as a park is divided into zones. These zones are the areas inside the property where guests need to be located. A zone can be as large or as small as needed. They can also be adjusted, expanded or minimized as necessary.

Guests are tracked as they pass along a path 103 through these zones via antennas such as an antenna 105 that are strategically placed throughout the property. These antennas, in return, send the tracking information to cell controllers such as cell controller 106, which conveys the information back to the central processing server or host computer 107 utilizing a wireless network. One example of such a system for the real-time location of people in a fixed environment is disclosed in the foregoing mentioned non-provisional patent application Ser. No. 09/992,668.

Facility Amenity Locator

The park amenity locator feature provides guests with an on-screen display of directions and/or maps to a set of pre-selected amenities located in the park or other confined area. These amenities can be any set of stand along locations such as restaurants, ATMs, restrooms, telephone, fast aid, show stadiums, concourses and popular attractions, as well as others.

This system enhancement may be particularly useful for first-time visitors that may not be familiar with the confined area of the facility, or for special needs guests who wish to find the most direct and accessible route from one place to another.

Facility Amenity Locator “Find an Amenity Using ‘Menu’ Mode”

Referring now to FIG. 2, the guest may be required to be registered as a user via a registration station such as the registration station 110 (FIG. 1) of the locating system 100 in order to use the amenity locator function. To enter into ‘FIND AN AMENITY USING MENU’ MODE the guest approaches the location station and waives or otherwise uses his or her locator or i.d. tag such as a tag 102 (FIG. 1) at a designated spot on the location station such as a station 108, as indicated at box 220 to enter his or her personal identification information into the system 100.

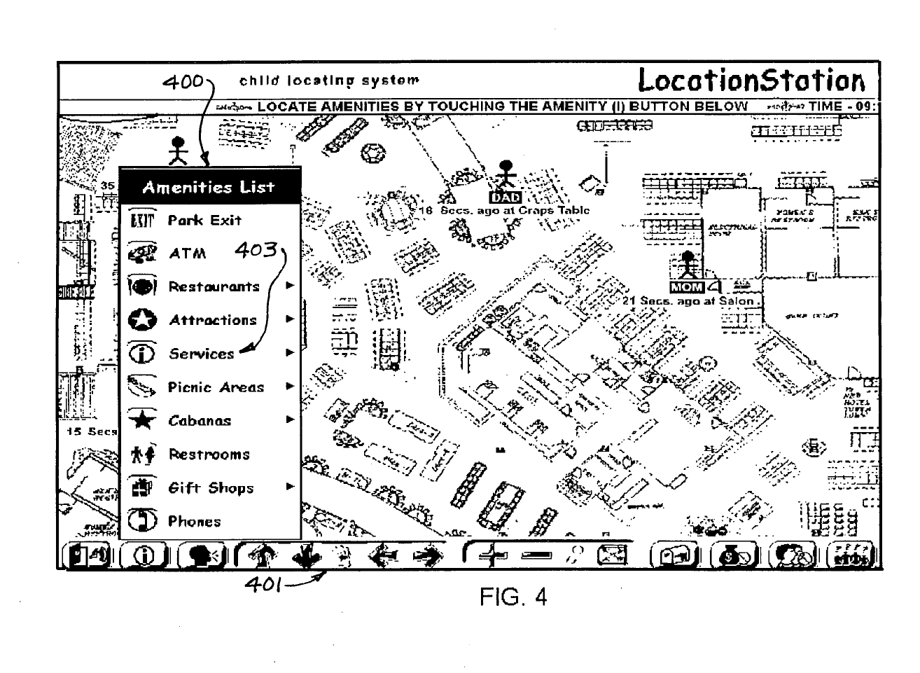

As shown in FIG. 4, a location station screen appears. As indicated in box 122, the guest should then do the selection by, for example, touching a designated area (not shown) on the screen (not shown) triggering the appearance of a “menu” message 400 listing the amenities available at the facility on a screen 401.

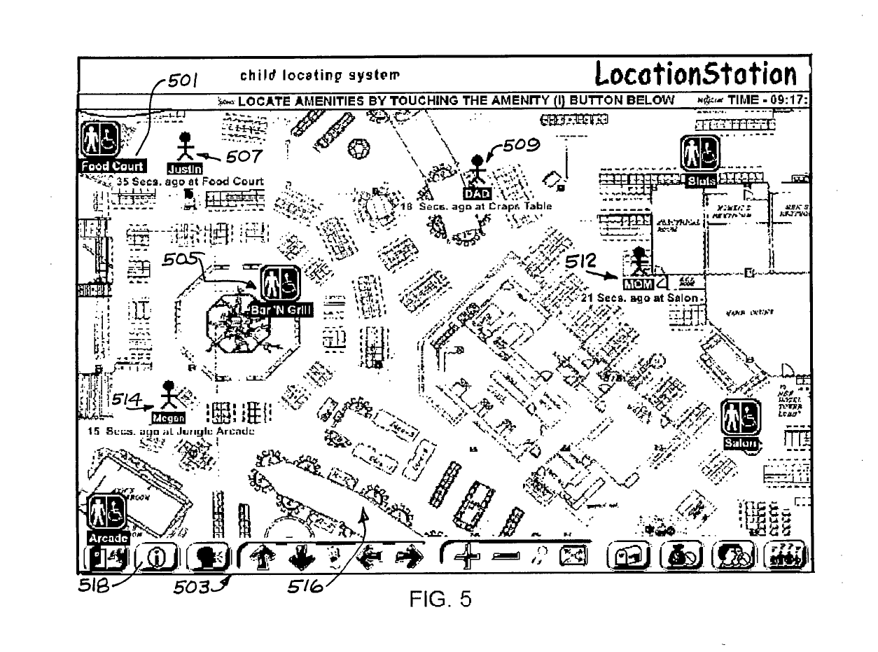

As indicated in box 123 and as shown in FIGS. 4 and 5, the guest then selects by, for example, touching the screen 401 on the amenity or service they desire and the locations of that amenity or amenities. For example, a selection “Restaurants” at 404 on the screen 401 can be touched or otherwise selected. As a result, as shown on FIG. 5, a “Food Court” icon 501 appears on a screen 503. Also, another restaurant icon such as a “Bar N Grill” icon 505 appears on the screen 503 which illustrates the various locations of the group members with group member icons such as “Justin” icon 507, “Dad” icon 509, “Mom” icon 512, and “Megan” icon 514 on a map 516.

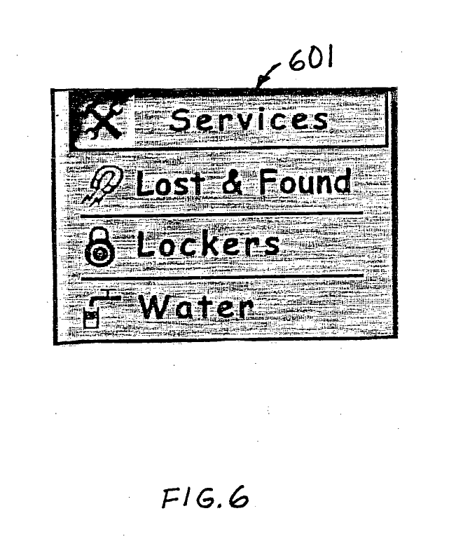

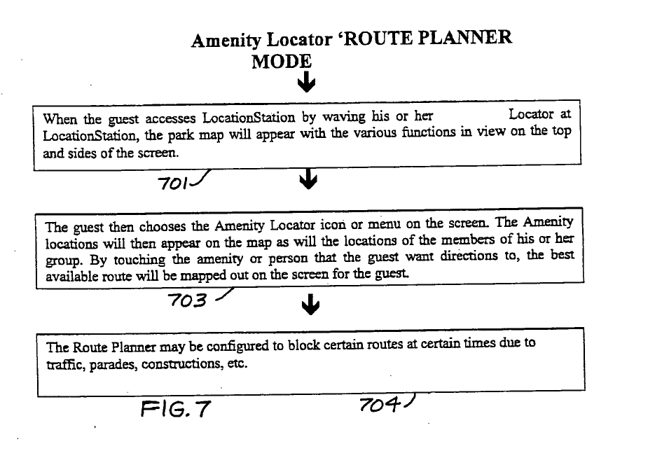

As shown in FIG. 6, a sub-listing message 602 of amenities appearing on a portion of the screen 401 can be displayed by touching one of the selections on the menu 400, such as “Services indicia 403.” In so doing, a menu of a sub-listing selections, such as a sub-listing message 601 (FIG. 6) of “Services” may be displayed for selection. The sub-list of services include a “Lost & Found” selection 602, a “Lockers” selection 604, and a “Water” selection 606.

Facility Amenity Locator “Find an Amenity Using ‘Icon’ Mode”

Referring now to FIG. 3, the guest may be required to be registered as a user via a registration station such as the registration station 110 (FIG. 1) of the locating system 100 in order to use the amenity locator function. To enter into ‘FIND AN AMENITY USING ICONS’ MODE the guest approaches a location station 108 and enters his or her personal identification information by, for example, waving his or her locator or i.d. tag at the designated spot on location station 110 as indicated at box 301.

As shown in box 303, a location station screen appears as indicated in FIG. 2. The guest should then touch the appropriate “icon” on the side or bottom of the screen. The various icons represent the attraction or service that they may require. For example, see a services icon 518 at the bottom of the screen 503 of FIG. 5.

As indicated in box 204, the guest then selects by, for example, touching the screen on the amenity icon such as the icon 518, they desire and the locations of that amenity. For example, should the restaurant icon be touched, then restaurant icons 501 and 505 as shown in FIG. 5 will appear on the screen.

Amenity Locator “Route Planner Mode”

Referring now to the ROUTE PLANNER MODE of operation according to an embodiment of the invention as illustrated in FIG. 7, the guest may be required to be registered as a user via the registration station of the 7 locating system 100 in order to use the route planner function. As indicated in box 701, when the guest accesses a location station such as station 108, by, for example, waiving his or her locator or personal identification tag at the location station to enter his or her personal identification information, the facility map appears with the various functions in view on the screen.

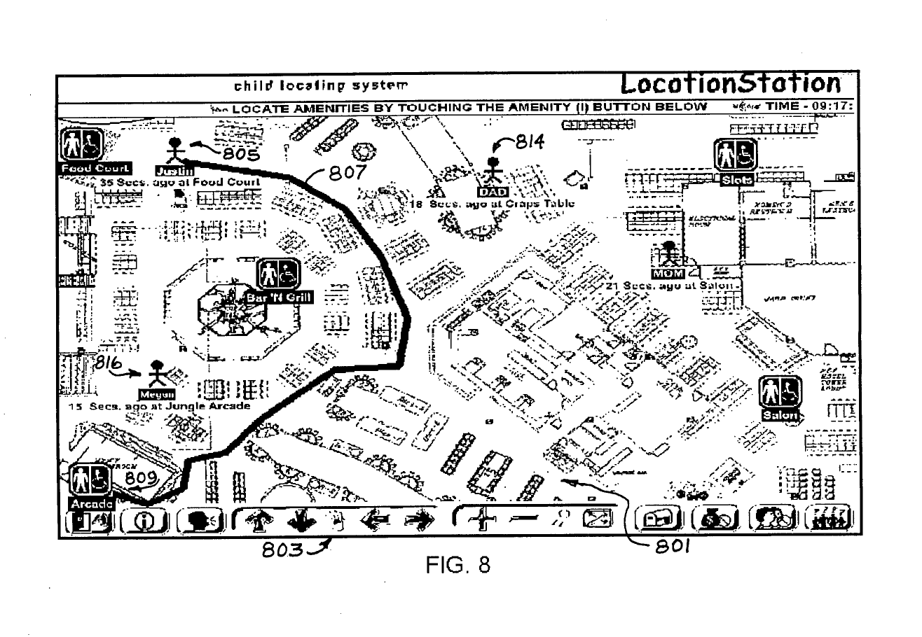

As indicated in box 703, the guest then selects the amenity locator icon such as the service icon 518 (FIG. 5) or menu such as the menu message 400 (FIG. 4) on the screen. The selected amenity locations then appear as shown in FIG. 8 on a map 801 displayed on a screen 803. Group member icons such as “Justin” icon 805 are also displayed on the map representing the members of the group to which the requesting member belongs. The location of the member icons represents the approximate location of the group member. The user touches or otherwise selects the desired amenity, person, or member icon on the location station screen 803 to request directions thereto. Direction indicia such as direction indicia 807 is then displayed on the map 801 of the screen 803 to indicate the best available route. In the example as illustrated in FIG. 8, the direction indicia 807 is in the form of a bold continuous line extending between a group member icon 805 and a selected amenity 809. In this example, both the member icon 805 and the amenity icon 809 are selected, and the best available route is determined and displayed. In this example, the determined route was not the shortest route, but was a best route for a handicapped person.

As indicated in box 904 of FIG. 7, the route planner software module may be configured to block certain routes at certain times due to traffic, parades, constructions, or other. The determined route may be a direct or shortest path to the desired group member or location; or a more scenic route; or a handicapped person's route; or other.

The direction indicia may be in the form of a series of arrows or bars or other symbols such as foot step indicia extending from a person or place icon, such as the “Dad” icon 814, to another person or place icon, such as a person icon 816. It may be desirable for some applications to have each direction indicia indicate a one-way direction from the person icon corresponding to the group member requesting the route, to a desired location. In other examples, it may be desirable to have the direction indicia to be configured in the shape of alpha-numeric characters to provide written directions to find the desired person or place.

While particular embodiments of the present invention have been disclosed, it is to be understood that various different modifications and combinations are possible and are contemplated within the true spirit and scope of the disclosed embodiments and the appended claims. There is no intention, therefore, of limitations to the exact disclosure herein presented.

1. A method of communication for a confined area of a facility, comprising:
receiving personal identification information of a guest into at least one of a set of stations distributed throughout the confined area;
displaying at least one person icon or place icon on a map of the confined area;
receiving a select signal indicative of at least one of a said person icons or place icons; and
displaying direction indicia to the selected icon

2. A method according to claim 1, wherein said place icon indicates an amenity, and further including displaying a menu message of a list of amenities disposed within the confined area.

3. A method according to claim 2, further including receiving an amenity select signal indicative of at least one of said amenities.

4. A method according to claim 3, further including displaying at least one amenity icon in response to said amenity select signal.

5. A method according to claim 1, wherein said direction indicia is in the form of a line extending to the selected indicia.

6. A method according to claim 1, further including determining a direct route to the selected icon, said direction indicia being indicative of the determined direct route.

7. A method according to claim 1, further including determining a scenic route to the selected icon, said direction indicia being indicative of the determined scenic route

8. A method according to claim 1, further including determining a handicapped person's route to the selected icon, said direction indicia being indicative of the handicapped person's route.

9. A method according to claim 1, further including displaying at least two of a group of person icons and place icons, said direction indicia between said at least two icons.

10. A system of communication for a confined area of a facility, comprising:
means for receiving personal identification information of a guest into at least one of a set of stations distributed throughout the confined area;
means for displaying at least one person icon or place icon on a map of the confined area;
means for receiving a select signal indicative of at least one of a said person icons or place icons; and
means for displaying direction indicia to the selected icon

11. A system according to claim 10, wherein said place icon indicates an amenity, and further including means for displaying a menu message of a list of amenities disposed within the confined area.

12. A system according to claim 11, further including means for receiving an amenity select signal indicative of at least one of said amenities.

13. A system according to claim 12, further including means for displaying at least one amenity icon in response to said amenity select signal.

14. A system according to claim 10, wherein said direction indicia is in the form of a line extending to the selected indicia.

15. A system according to claim 10, further including means for determining a direct route to the selected icon, said direction indicia being indicative of the determined direct route.

16. A system according to claim 10, further including means for determining a scenic route to the selected icon, said direction indicia being indicative of the determined scenic route

17. A system according to claim 10, further including means for determining a handicapped person's route to the selected icon, said direction indicia being indicative of the handicapped person's route.

18. A system according to claim 10, further including means for displaying at least two of a group of person icons and place icons, said direction indicia between said at least two icons.

19. A software system of communication for a confined area of a facility, comprising:
module for receiving personal identification information of a guest into at least one of a set of stations distributed throughout the confined area;
module for displaying at least one person icon or place icon on a map of the confined area;
module for receiving a select signal indicative of at least one of a said person icons or place icons; and
module for displaying direction indicia to the selected icon

20. A software system according to claim 19, wherein said place icon indicates an amenity, and further including module for displaying a menu message of a list of amenities disposed within the confined area.

21. A software system according to claim 20, further including module for receiving an amenity select signal indicative of at least one of said amenities.

22. A software system according to claim 21, further including module for displaying at least one amenity icon in response to said amenity select signal.

23. A software system according to claim 19, wherein said direction indicia is in the form of a line extending to the selected indicia.

24. A software system according to claim 19, further including module for determining a direct route to the selected icon, said direction indicia being indicative of the determined direct route.

25. A software system according to claim 19, further including module for determining a scenic route to the selected icon, said direction indicia being indicative of the determined scenic route

26. A software system according to claim 19, further including module for determining a handicapped person's route to the selected icon, said direction indicia being indicative of the handicapped person's route.

27. A software system according to claim 19, further including module for displaying at least two of a group of person icons and place icons, said direction indicia between said at least two icons.
